(19) United States
(12) Patent Application Publication
(10) Pub. No.: US 2011/0238715 A1
(43) Pub. Date: Sep. 29, 2011

(54) COMPLEX OBJECT MANAGEMENT THROUGH FILE AND DIRECTORY INTERFACE

(75) Inventors: Steven T. Quinn, San Diego, CA (US); Michael C. Hay, Yokohama (JP)

(73) Assignee: HITACHI DATA SYSTEMS CORPORATION, Santa Clara, CA (US)

(21) Appl. No.: 12/731,703

(22) Filed: Mar. 25, 2010

(51) Int. Cl. G06F 17/30

(52) U.S. Cl. 707/822; 715/853; 707/829; 707/E17.01

(57) ABSTRACT

A method for representing a computer-related resource in a computer-related system environment comprises creating an object model of the resource, the object model including objects that correspond to components of the resource, configuration information of the objects, and relationships among the objects; providing a resource application program interface to allow communication with and access to the components of the resource; mapping the objects of the object model to files and directories of a file and directory structure; presenting the file and directory structure via a file system application program interface to allow an application to manipulate the files and directories so as to manipulate the components of the resource via the resource application program interface; and manipulating the components of the resource based on manipulation of the files and directories from the application.

### BACKGROUND OF THE INVENTION

The present invention relates generally to computer and software systems for managing resources in a computing and/or storage system environment (i.e., computer-related resources in a computer-related environment) and, more particularly, to systems for presenting an object model of a resource as a set of files and directories organized in a file directory tree which is used to manipulate the resource.

Many types of conventional computing systems operate software programs that include a graphical user interface (GUI) that allows a user of the computing system to graphically view, manage, control and/or configure various types of hardware or software resources in an environment in which the computing system operates. The graphical user interface may allow, for example, a user of the computing system to interact with the computing system and its associated software applications, filesystem(s), data, devices and/or peripherals. The computing system may operate in a networked environment and the software program may be a network management application that provides the graphical user interface to allow the user to remotely manage and control other computing systems and/or resources that are remotely coupled via a network. Resources that may be graphically managed in this manner can include storage system and device resources such as disks, file systems, volumes and the like, network device resources such as switches, host computer system resources such as clients or servers, and software applications that operate on one or more of such components. A user views, manages, configures or otherwise operates on such resources via manipulation of a representation of the resources that the software application provides (e.g., displays or renders) on the graphical user interface.

Conventional resource management software applications (e.g., network or device manager software) typically provide a representation of each resource on the graphical user interface using a respective icon paired with a resource identifier. The icon provides a small graphical representation of the resource while the resource identifier is a text or character string name for the resource. The software application displays the resource identifier in a fully qualified manner. A fully qualified resource identifier conveys the naming scheme that the software or operating system imposes resources. For example, a fully qualified resource identifier may include a string of alphanumeric characters (e.g., text and/or numbers) to indicate a specific file and path name for that file in a file system in order to uniquely identifies each resource.

In many computing system environments, resources have hierarchical relationships with other resources (e.g., files in a file system hierarchy). Due to such hierarchical relationships and in order to provide uniqueness for each resource identifier, a fully qualified resource identifier for a resource in a conventional resource management application includes a “hierarchy location” such as a pathname for the resource in the resource hierarchy (e.g., the directory or folder path of a file in a file system hierarchy) followed by the resource's “simple name,” which is the name of the resource (e.g., the file name of the file in the file system). As an example, if the resource is a text file having a simple name “myfile.txt” and has the hierarchical file system location “/user/person/home/textfiles/,” then a fully qualified resource identifier for this resource might appear as “user/person/home/textfiles/myfile.txt” in the graphical user interface.

U.S. Pat. No. 7,032,186 discloses a computer system and method provide a systems for representing resource(s) in a computing system environment by creating an object to represent a resource in the computing system environment and assigning an object identifier to the object. The object identifier includes at least a simple name of the object and a home of the object. The system displays at least one representation of the object on a graphical user interface. Each representation of the object includes the simple name of the object and, if a home condition exists for that representation of the object displayed on the graphical user interface, the representation further includes the home of the object, and if a home condition does not exist for that representation of the object, the representation of the object displayed on the graphical user interface does not include the home of the object. The graphical user interface can also provide groups that are transparent and terminal in order to allow visual arrangement of resource representations without affecting those resources.

U.S. Pat. No. 6,862,736 discloses an object manager for common information model that provides a common way to access information, but it does not deal with file-based access.

### BRIEF SUMMARY OF THE INVENTION

Exemplary embodiments of the invention are directed to methods and systems to present an object model of a resource through a file system as a set of files and directories organized in a file directory tree and allowing manipulation of the resource through manipulation of the files and directories in the file directory tree. In contrast, U.S. Pat. No. 7,032,186 provides a file view only via a GUI. In the present invention, through a file directory tree view provided via a common application interface, the user has easily access the configuration information of the file system instead of having to collect and edit the information using different applications such as GUIs. In specific embodiments, the Object Model API (Application Programming Interface) gathers and stores the configuration information of the objects/components, and then the File System API creates the file directory tree view based on the stored information and provides the file directory tree view to the application so that the user can view the information via the common API. Alternatively, the user can view the information via a web browser. Through the file directory tree views, the user can access the file directory trees easily, including the reading and writing of data. The process sequence between the file system interface and the object model interface is transparent to the user. Heretofore, there has not been such a file system interface for presenting the directory view to the user.

In accordance with an aspect of the present invention, a method for representing a computer-related resource in a computer-related system environment comprises creating an object model of the resource, the object model including objects that correspond to components of the resource, configuration information of the objects, and relationships among the objects; providing a resource application program interface to allow communication with and access to the components of the resource; mapping the objects of the object model to files and directories of a file and directory structure; presenting the file and directory structure via a file system application program interface to allow an application to manipulate the files and directories so as to manipulate the components of the resource via the resource application program interface; and manipulating the components of the resource based on manipulation of the files and directories from the application.

In some embodiments, the file and directory structure is presented via a file system application program interface to allow an application to manipulate the files and the directories using file system command line interfaces and file system application program interfaces. The file and directory structure is presented on a graphical user interface display as a file directory tree laying out the object model and relationships among the objects as represented by the files and the directories in the file and directory structure. The object model further includes one or more association objects which do not correspond to components of the resource, and the one or more association objects are mapped to the file and directory structure.

In specific embodiments, the method further comprises creating the file and directory structure which includes creating a root directory name for the resource; collecting resource data from the resource; identifying, for data objects, directory names and locations and file names and locations; creating directories corresponding to the directory names and locations; and identifying format for contents of files and creating the files corresponding to the file names and locations. The object model further includes one or more association objects which do not correspond to components of the resource, the one or more association objects are mapped to the file and directory structure, and creating the file and directory structure further includes identifying, for the one or more association objects, one or more directory names and locations and file names and locations; creating directories corresponding to the directory names and locations for the one or more association objects; and identifying format for contents of files and creating the files corresponding to the file names and locations for the one or more association objects.

In some embodiments, the method further comprises updating the object model based on changes in the file and directory structure, and communicating with the resource to issue one or more configuration change requests based on the updated object model. The application is one of an operating system shell, a resource management application, or a Web server. Each directory has a directory path which is used as a unique identifier to access instances based on scoping rules. The resource comprises a storage array having physical and logical components.

In accordance with another aspect of the invention, a system for representing a computer-related resource in a computer-related system environment comprises a processor; a memory; an object model interface module to create an object model of the resource, the object model including objects that correspond to components of the resource, configuration information of the objects, and relationships among the objects; a resource application program interface module to provide a resource application program interface to allow communication with and access to the components of the resource by converting object model requests to resource commands and vice versa; an object model interface module to map the objects of the object model to files and directories of a file and directory structure; and a file system interface module to present the file and directory structure via a file system application program interface to allow an application to manipulate the files and directories so as to manipulate the components of the resource via the resource application program interface.

In some embodiments, the file system interface is a file system application program interface to allow an application to manipulate the files and the directories via a command shell using file system command line interfaces and file system application program interfaces. The file system interface presents the file and directory structure on a graphical user interface display as a file directory tree laying out the object model and relationships among the objects as represented by the files and the directories in the file and directory structure. The object model further includes one or more association objects which do not correspond to the components of the resource, and the object model interface module maps the one or more association objects to the file and directory structure.

In specific embodiments, the object model interface module is configured to create the file and directory structure which includes creating a root directory name for the resource; collecting resource data from the resource; identifying, for data objects, directory names and locations and file names and locations; creating directories corresponding to the directory names and locations; and identifying format for contents of files and creating the files corresponding to the file names and locations. The object model further includes one or more association objects which do not correspond to the components of the resource. The object model interface module maps the one or more association objects to the file and directory structure. Creating the file and directory structure by the object model interface module further includes identifying, for the one or more association objects, one or more directory names and locations and file names and locations; creating directories corresponding to the directory names and locations for the one or more association objects; and identifying format for contents of files and creating the files corresponding to the file names and locations for the one or more association objects. The object model interface module is configured to update the object model based on changes in the file and directory structure, and communicate with the resource to issue one or more configuration change requests based on the updated object model.

Another aspect of the invention is directed to a computer-readable storage medium storing a plurality of instructions for controlling a data processor to represent a computer-related resource in a computer-related system environment. The plurality of instructions comprise instructions that cause the data processor to create an object model of the resource, the object model including objects that correspond to components of the resource, configuration information of the objects, and relationships among the objects; instructions that cause the data processor to provide a resource application program interface to allow communication with and access to the components of the resource; instructions that cause the data processor to map the objects of the object model to files and directories of a file and directory structure; and instructions that cause the data processor to present the file and directory structure via a file system application program interface to allow an application to manipulate the files and directories so as to manipulate the components of the resource via the resource application program interface.

In specific embodiments, the file and directory structure is presented via a file system application program interface to allow an application to manipulate the files and the directories using file system command line interfaces and file system application program interfaces. The file and directory structure is presented on a graphical user interface display as a file directory tree laying out the object model and relationships among the objects as represented by the files and the directories in the file and directory structure.

These and other features and advantages of the present invention will become apparent to those of ordinary skill in the art in view of the following detailed description of the specific embodiments.

### BRIEF DESCRIPTION OF THE DRAWINGS

FIG. 1 illustrates a conceptual model showing an object model for a storage array with an array interface, which is presented to users through an object model API, a file system API, and either an application or a web server via a browser.

FIG. 2 shows the components that would be involved when accessing the file system via a command shell.

FIG. 3 shows the components that would be involved when accessing the file system via an NFS or a CIFS connection.

FIG. 4 shows the components that would be involved when accessing the file system via an application.

FIG. 5 shows a high-level view of the processes and control and object flow needed to populate the directory tree according to a discovery process.

FIG. 6 shows the command sequence mapped to the discovery process of FIG. 5.

FIG. 7 shows a high-level view of the processes and control and object flow needed to process configuration change requests.

FIG. 8 shows the command sequence mapped to the configuration change process of FIG. 7.

FIG. 9 shows a high-level view of the processes and control and object flow needed to process an asynchronous event notification from the storage array.

FIG. 10 shows the command sequence mapped to the event notification process of FIG. 9.

FIG. 11 shows an example illustrating many of the objects that are used to model a storage array and their associations.

FIG. 12 shows the object descriptions for the diagram of FIG. 11.

FIG. 13 shows a tree view of a sample directory listing (not all subdirectories implemented in this example) using the Windows tree CLI command.

FIG. 14 shows the same sample directory listing using Windows Explorer.

FIG. 15 shows a sample file directory view for a computer storage resource.

FIG. 16 shows another sample file directory view for a computer storage resource.

FIG. 17 shows an example of a Browser view of a file.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

In the following description, relative orientation and placement terminology, such as the terms horizontal, vertical, left, right, top and bottom, is used. It will be appreciated that these terms refer to relative directions and placement in a two dimensional layout with respect to a given orientation of the layout. For a different orientation of the layout, different relative orientation and placement terms may be used to describe the same objects or operations.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for presenting an object model of a resource as a set of files and directories organized in a file directory tree which is used to manipulate the resource.

According to specific embodiments, the present resource management scheme takes a complex object model such as one representing one or more storage arrays and presents it through a file system as a set of files and directories organized in a directory tree. The directory hierarchical structure lays out the object model and relationships between the objects. This allows gathering of system configuration information from simple file and directory commands. The scheme further allows manipulation of the configuration of a storage array through manipulation of the files and directories using standard file system command line interfaces or CLIs (e.g., type, cat, del, etc.) and file system APIs (e.g., fwrite, fread, or other methods in the C programming language).

The file system can be exposed across an IP network through industry standard file system interfaces such as CIFS (Common Internet File System) and NFS (Network File System). The file system can be managed through the native OS (Operating System) methods or via special libraries such as Linux's FUSE (Filesystem in Userspace). Other protocols such as HTTP/HTTPS (e.g., web servers) and FTP (File Transfer Protocol) can be added with minimal effort because they just need to access the underlying filesystem, as opposed to something like a Servlet-based architecture that would require custom coding for each object returned.

Moreover, the resource management scheme may use the directory path as a unique identifier to access instances, much like a URI (Uniform Resource Identifier), based on scoping rules. For example, if a HostGroup is scoped to a Port which is scoped to a storage array; one possible file and directory path for this would be: /StorageArray/AMS2100_{—}1234/Ports/FCPort_CL1-A/HG_{—}0001.xml. The format for this example is <root directory> “/” <Array IDentifier> “/” <port identifier> “/” <host group identifier>.

A. Conceptual Component Model

Embodiments of the invention provide a resource management scheme designed to transform a complex object model into an easily understood file and directory interface. An object model is a collection of classes and methods representing aspects and behaviors of an underlying system such as a file system. Object models are usually presented to users through computer languages, applications, and application programming interfaces (APIs).

Instead of relying on these languages, applications, and APIs, the present resource management scheme renders the object model as an active file and directory interface. The file and directory interface itself is very pervasive and mature. Specifically, files and directories have been coupled to computers for nearly 30 years and are based on common functions and “objects” that the both lay person and computer scientist alike can understand, namely, files. For example, a secretary may receive a letter from a potential client and start a physical record of the client in a folder containing the letter and other files. Later on, the secretary may open the folder reviewing specific file contents at the request of the client, or shred specific files at the request of the client. Similarly, a computer scientist could create a directory or folder and store files within the folder when he is creating a new research product. Later on as the project evolves, he can open each online file to add new content or create new files within the folder, and finally as the project winds down, he can securely delete or shred the contents of the folder.

A.1. Components

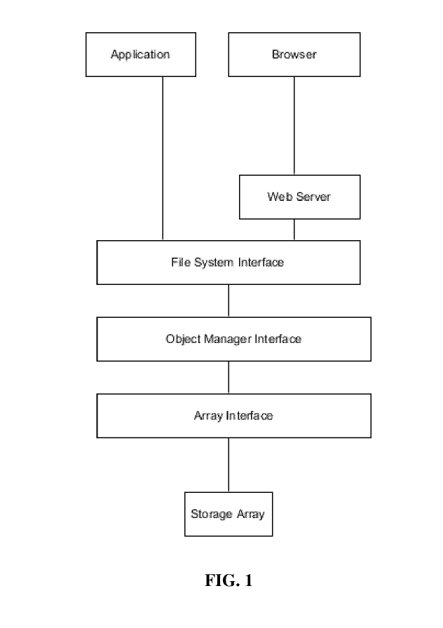

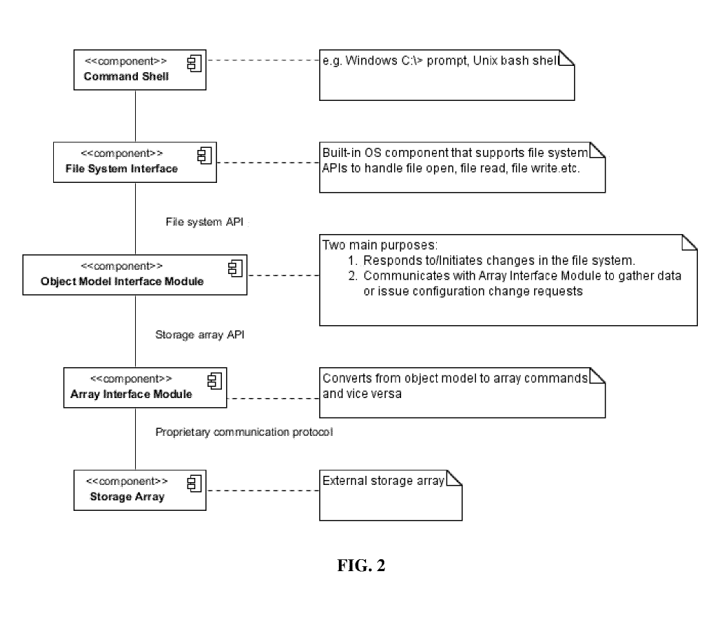

FIG. 1 illustrates a conceptual model showing an object model for a storage array with an array interface, which is presented to users through an object model API, a file system API, and either an application or a web server via a browser. The conceptual model has the following components. The Application represents a consumer of the file system interface. This can be an operating system shell or an application such as a storage resource management (SRM) application. The Browser represents a web browser such as Internet Explorer that is a client of a web server. The Web Server represents an application that consumes the file system interface and exposes data via an HTTP/HTTPS interface. The File System Interface is a component that supplies an interface to create, read, and manage files and directories. The Object Manager Interface is a component that represents the objects and methods that correspond to logical and physical elements of the storage array and that map them to the file system via the File System Interface. The Array Interface is a component that provides the bridge between the Object Manager Interface objects and methods and the Storage Array via the storage array APIs. The Storage Array represents the actual storage array hardware.

A user would interact with the storage array via the Application component. The Application component will use standard file system library calls to create, read, update, and delete files (a.k.a. CRUD), and create, modify, and delete directories. This can be done via an operating system supplied command line interface such as a Windows or Unix shell or via a graphical user interface such as Windows Explorer window or via an application that provides a user interface that may not be directly mapped to a file system view of the data. User access can also be done via a Browser that communicates with a Web Server that performs the same create, read, update, and delete files, and create, modify, and delete directories functionality as an Application. The Web Server makes this functionality available via the HTTP/HTTPS interface to a Browser.

The File System Interface supplies an API to support the creation, reading, updating, and deleting of files and the creation, modification, and deletion of directories. This functionality is usually provided by one or more statically or dynamically linked libraries supported by a number of different programming languages. The creation, modification, and deletion of the files and directories on physical media or whatever means of persistent storage is used by the operating system is handled in this component, usually by making other internal operating system-specific calls. The Object Manager Interface (or Object Model Interface) takes the physical and logical components of the storage array and maps them to a file and directory structure. These storage array objects are not designed to be mapped this way; hence the Object Model Interface handles this translation between storage array model and file system layout. The Object Model Interface may also add associations between objects that are not present in the storage array, thus adding to the richness of the object model and the value to the end user.

The Array Interface supplies the API(s) needed to communicate with the storage array. The Object Model Interface makes use of these APIs to create, read, update, and delete physical or logical components of the Storage Array. The Storage Array represents the physical storage array that is being managed.

The Storage Array is an example of a resource. In general, the Storage Array block is a Resource block, and the Array Interface is a Resource Application Program Interface module. Furthermore, the Resource in general may represent a group or a set of resources having a plurality of resources as components of the Resource.

The conceptual model of FIG. 1 can be implemented in a resource management system having a processor and a memory, and a plurality of modules that are executed to perform resource management. These modules include the Application and/or the Browser and the Wed Server, a File System Interface module, an Object Model Interface module, and an Array Interface module (or in general a Resource Application Program Interface module). These modules may be software modules stored in the memory to be executed by the processor.

A.2. OS Shell Access

FIG. 2 shows the components that would be involved when accessing the file system via a command shell. In this example, the user interacts with the Command Shell component, which is supplied by the operating system to manipulate local files on the computer by issuing command line interface (CLI) commands. These CLI commands make calls to the underlying API provided by the File System Interface, which is supplied by the operating system as a built-in component that supports the file system APIs to handle file open, file read, file read, etc. The Object Model Interface Module creates the files initially, using the same file system API. The data used to create the files is supplied by making calls to the storage array API supplied by the Array Interface Module. The Array Interface Module uses the storage array proprietary API to communicate with the Storage Array to gather data from the Storage Array. It converts object model requests to array commands and vice versa.

The Object Model Interface Module monitors the file system for changes made by the user. When storage array configuration changes are requested, the Object Model Interface Module detects the change via the file changes. It then uses the storage array proprietary API to communicate with the Storage Array to make configuration changes on the Storage Array via the storage array proprietary interface.

A.3. Remote Access (CIFS/NFS)

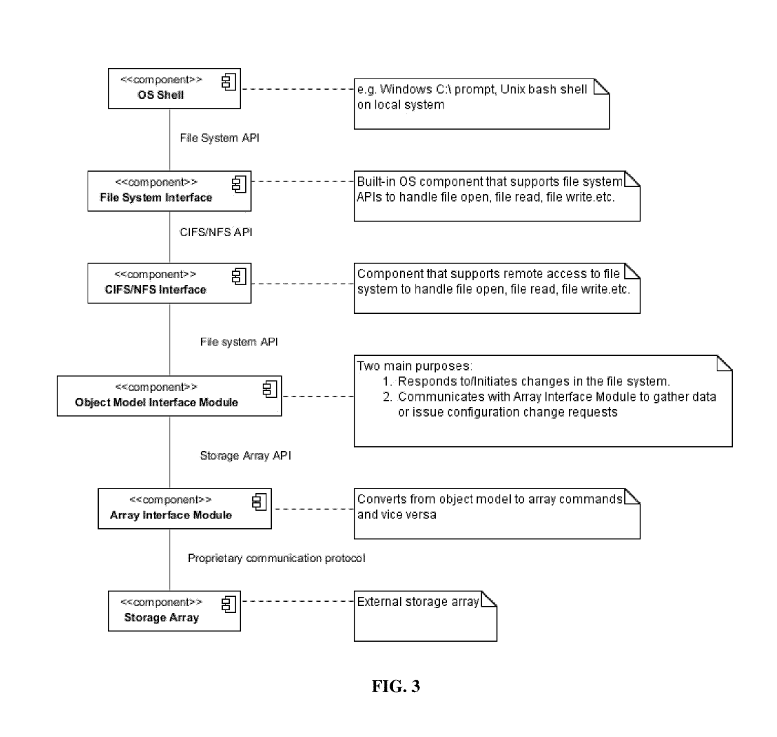

FIG. 3 shows the components that would be involved when accessing the file system via an NFS or a CIFS connection. In this example, the user interacts with the Command Shell component, which is an OS Shell supplied by the operating system (OS) to manipulate remote files on the computer by issuing command line interface (CLI) commands. These commands make calls to the underlying API provided by the File System Interface, which is supplied by the operating system as a built-in component that supports the file system APIs to handle file open, file read, file read, etc. The File System Interface knows that these files are located on a remote system and calls the CIFS/NFS Interface to send and receive the file system API calls across the network to the remote system. The CIFS/NFS Interface supports remote access to the file system to handle file open, file read, file write, etc. The Object Model Interface Module has two main purposes. The first is to respond to or initiate changes in the file system. The second is to communicate with the Array Interface Module to gather data or issue configuration change request. The Object Model Interface Module creates the files initially, using the file system API on the remote system. The data used to create the files is supplied by making calls to the storage array API supplied by the Array Interface Module. The Array Interface Module uses the storage array proprietary API to communicate with the Storage Array to gather data from the Storage Array. The Array Interface Module converts object model requests to array commands and vice versa.

The Object Model Interface Module monitors the file system for changes made by the user. When storage array configuration changes are requested, the Object Model Interface Module detects the change via the file changes. It then uses the storage array proprietary API to communicate with the Storage Array to make configuration changes on the Storage Array via the storage array proprietary interface.

A.4. Remote Access (HTTP/FTP)

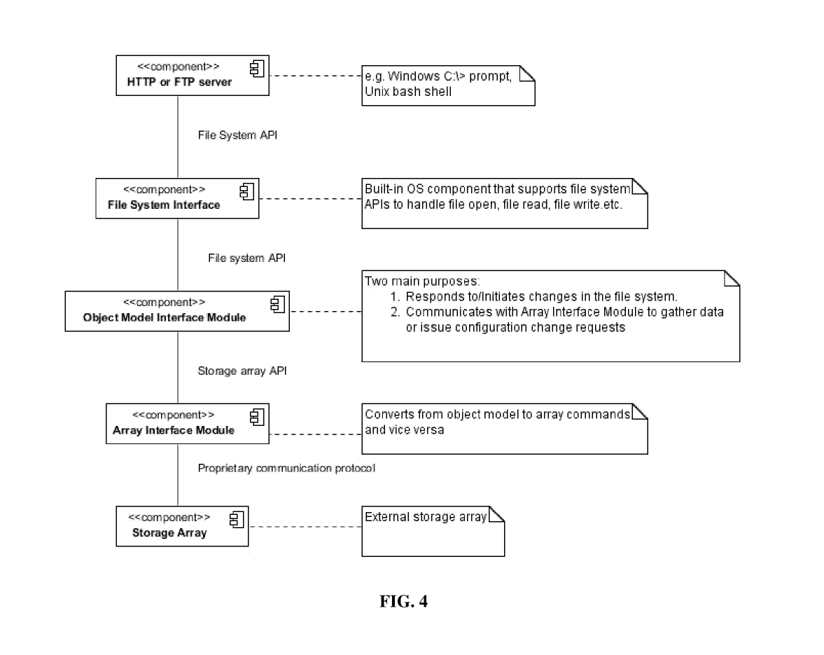

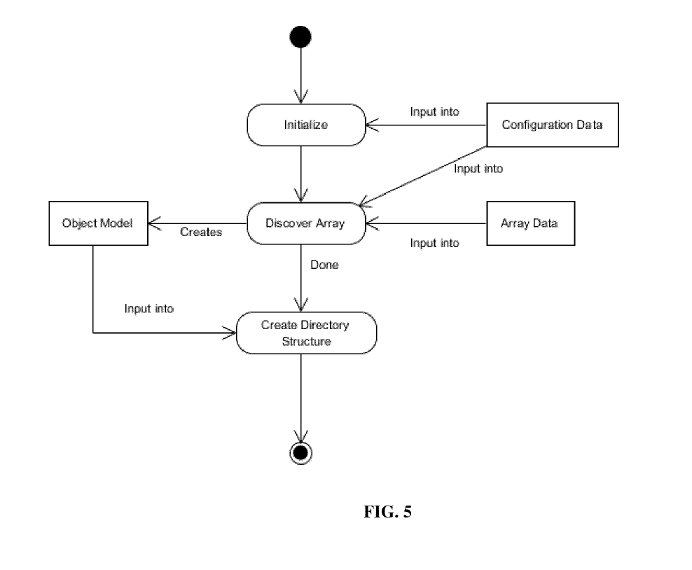

FIG. 4 shows the components that would be involved when accessing the file system via an application. In this case, the user interacts with an HTTP or FTP server. In this example, the HTTP or FTP server interacts with the File System Interface by making calls to the underlying API provided by the File System Interface, which is supplied by the operating system as a built-in component that supports the file system APIs to handle file open, file read, file read, etc. The Object Model Interface Module has two main purposes. The first is to respond to or initiate changes in the file system. The second is to communicate with the Array Interface Module to gather data or issue configuration change request. The Object Model Interface Module creates the files initially, using the same file system API. The data used to create the files is supplied by making calls to the storage array API supplied by the Array Interface Module. The Array Interface Module uses the storage array proprietary API to communicate with the Storage Array to gather data from the Storage Array. The Array Interface Module converts object model requests to array commands and vice versa.

The Object Model Interface Module monitors the file system for changes made by the user. When storage array configuration changes are requested, the Object Model Interface Module detects the change via the file changes. It then uses the storage array proprietary API to communicate with the Storage Array to make configuration changes on the Storage Array via the storage array proprietary interface.

B. Process Diagrams

This section describes processes to provide the file directory tree to the user, including data collection (which takes place at the Object Model Interface), creation of a directory tree structure based on the collected data (which takes place at File System API), and displaying the directory tree structure on the Application/File System APIs. It further describes how a user or a process may access the Storage Array via the file system and how the components in the component model described in Section A will interact to provide the data to the user or the process.

B.1. Discovery

FIG. 5 shows a high-level view of the processes and control and object flow needed to populate the directory tree according to a discovery process. In this diagram, boxes with rounded corners represent processes, boxes with straight corners represent data, and lines indicate control flow (between processes) or data flow (between processes and data).

In step 502, the program initializes the components in the file system using configuration data 512 related to the configuration of the components. In a preferred embodiment, the configuration data includes connection information for discovering the storage array. In step 504, the program performs a discover array process that captures the storage array configuration and creates the object model 516. This discover array process will use the storage array API(s) to collect the configuration information including the storage array-based configuration data or array data 514. In step 506, the program creates the directory tree and files in the proper locations using input information from the object model 516.

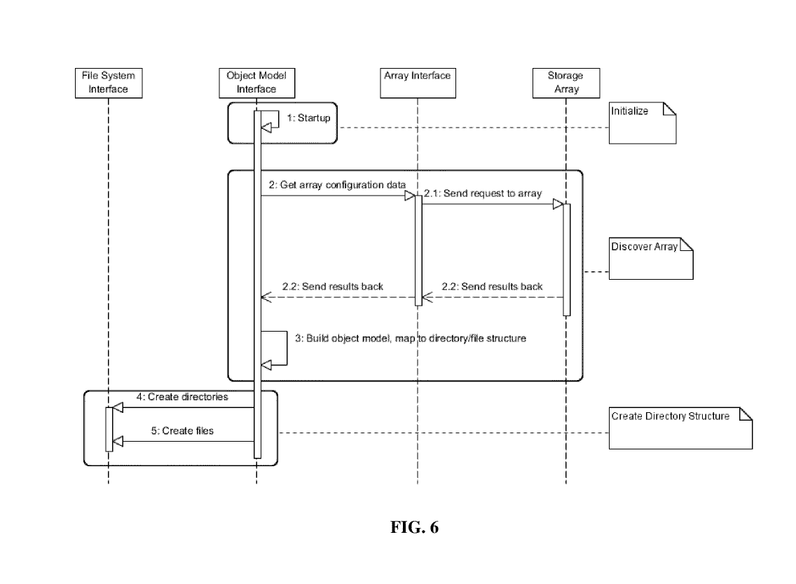

FIG. 6 shows the command sequence mapped to the discovery process of FIG. 5. To initialize (step 502), the object model interface performs start up (sequence 1). To perform the “discover array” process (step 504), the object model interface requests the array configuration data 514 (sequence 2) via the array interface from the storage array (sequence 2.1). The storage array sends the results back via the array interface to the object model interface (sequence 2.2). The object model interface builds the object model and maps it to the directory/file structure (sequence 3). To create the directory/file structure (step 506), the object model interface creates the directories (sequence 4) and the files (sequence 5) to the file system interface.

B.2. Configuration Change

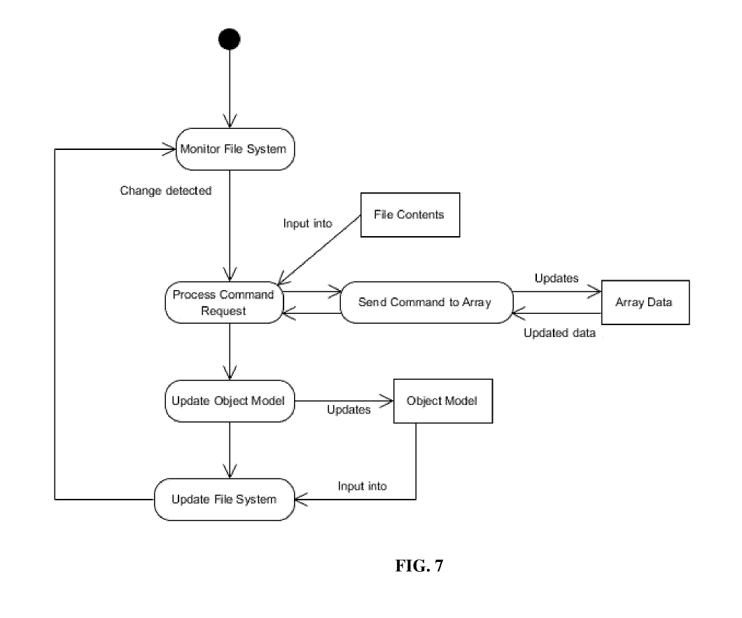

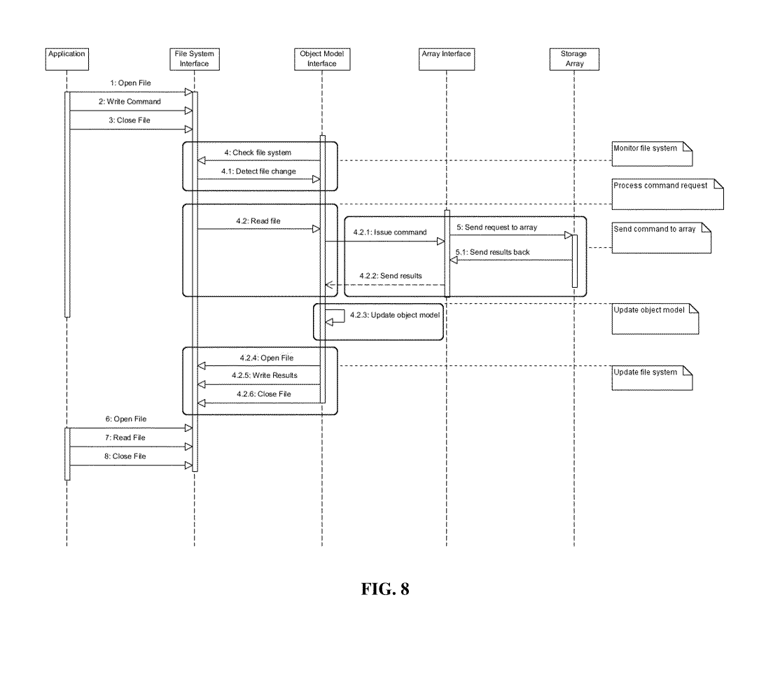

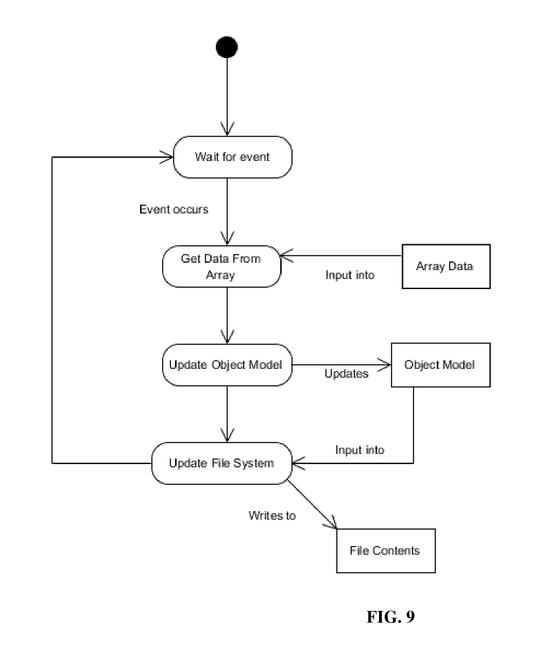

FIG. 7 shows a high-level view of the processes and control and object flow needed to process configuration change requests. In this diagram, boxes with rounded corners represent processes, boxes with straight corners represent data, and lines indicate control flow (between processes) or data flow (between processes and data).

In step 702, the program performs a “monitor file system” process to monitor the file system for changes to files and/or directories, indicating a request to perform some action. In step 704, using file contents 712 which include data contained in the files and/or directories that changed, the program performs a “process command request” process to interpret command requests and sends the command requests to the “send command to array” process of step 706. In step 706, the program communicates with the storage array via the storage array API(s) to perform configuration change requests and send results back to the “process command request” process. It involves updating the array data 514 and providing the updated array data to the “process command request” process 704. In step 708, the program performs an “update object model” process to update the object model 516 based on the new configuration. The object model 516 stores storage array configuration data and metadata such as relationships between objects. In step 710, the program performs an “update file system” process to apply the object model changes from the object model 516 to the file system.

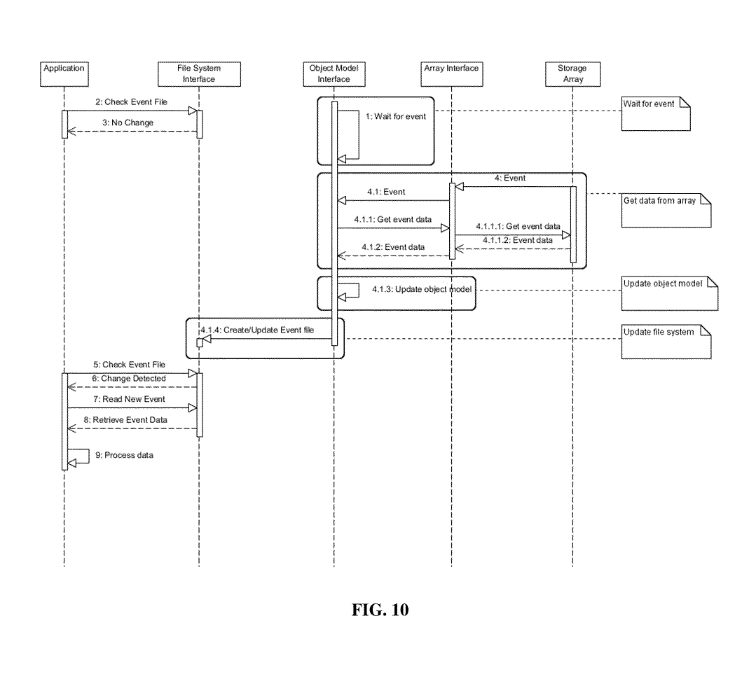

FIG. 8 shows the command sequence mapped to the configuration change process of FIG. 7. The application opens a file via the file system interface (sequence 1), sends a write command (sequence 2), and closes the file (sequence 3). To monitor the file system (step 702), the object model interface checks the file system via the file system interface (sequence 4) and receives detected file change (sequence 4.1). To process the command request (step 704), the object model interface reads the file via the file system interface (sequence 4.2) to obtain the file contents 712 and performs the “process command request” process by issuing the command (sequence 4.2.1). To process the “send command to array” process (step 706), the array interface sends the request to the storage array (sequence 5), which sends the results back via the array interface (sequence 5.1) to the object model interface (sequence 4.2.2). To update the object model (step 708), the object model interface updates the object model 516 based on the new configuration (sequence 4.2.3). To update the file system (step 710), the object model interface opens the file (sequence 4.2.4), writes results (sequence 4.2.5), and closes the file (sequence 4.2.6) via the file system interface to apply the object model changes from the object model 516 to the file system. The application opens the file via the file system interface (sequence 6), reads the file (sequence 7), and closes the file (sequence 8).

B.3. Event Notification

FIG. 9 shows a high-level view of the processes and control and object flow needed to process an asynchronous event notification from the storage array. In this diagram, boxes with rounded corners represent processes, boxes with straight corners represent data, and lines indicate control flow (between processes) or data flow (between processes and data).

In step 902, the program performs the “wait for event” process to wait for some event to happen on the storage array (e.g., disk drive failure, user log in, etc.). In step 904, the program performs the “get data from array” process to communicate with the storage array via the storage array API(s) to retrieve the event information. The information comes from the array data 514. In step 906, the program performs the “update object model” process to update the object model 516 based on the new configuration. In step 908, the program performs the “update file system” process to apply the object model changes to the file system using input from the object model 516 by writing to the file contents 712 with data from the event.

FIG. 10 shows the command sequence mapped to the event notification process of FIG. 9. The application checks the event file (sequence 1) and finds no change (sequence 2). In step 902, the object model interface waits for an event (sequence 3). To get data from array (step 904), the object model interface communicates with the storage array via the storage array API(s) (sequences 4 and 4.1) to retrieve the event information (sequences 4.1.1, 4.1.1.1, 4.1.1.2, and 4.1.2). In step 906, the object model interface updates the object model 516 based on the new configuration (sequence 4.1.3). In step 908, the object model interface creates or updates the event file via the file system interface to apply the object model changes to the file system (sequence 4.1.4). Subsequently, the application checks the event file via the file system interface (sequence 5) and detects change (sequence 6), reads the new event (sequence 7) and retrieves the event data via the file system interface (sequence 8), and acts on the event (sequence 9).

C. Example of a Complex Object Model—Storage Array

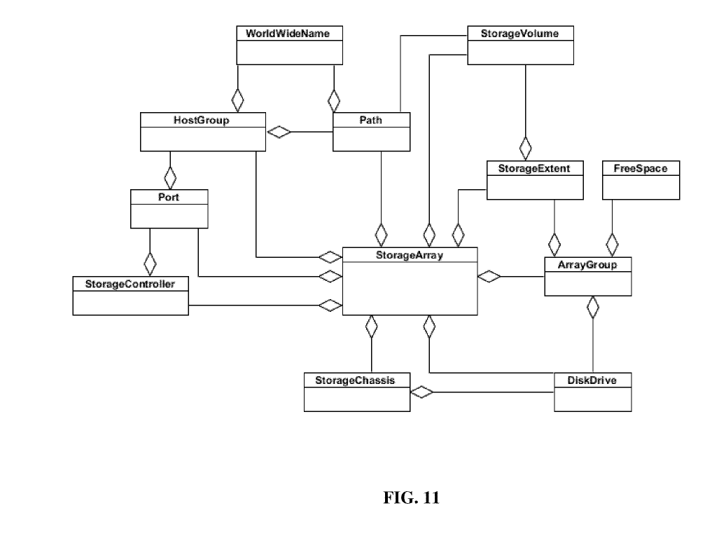

FIG. 11 shows an example illustrating many of the objects that are used to model a storage array and their associations. For simplicity, not all objects and associations are shown. In the diagram, properties are left out to keep the diagram manageable. Boxes represent physical or logical objects in the array (e.g., a disk drive, an I/O port, or a logical volume). Lines between boxes represent association objects that relate one physical or logical object with another. A straight line connecting two objects indicates a one-to-one relationship between the two objects. A line with a diamond on the end indicates that one object has a one-to-many association with the other (for example, a Path may be secured with many WorldWideNames).

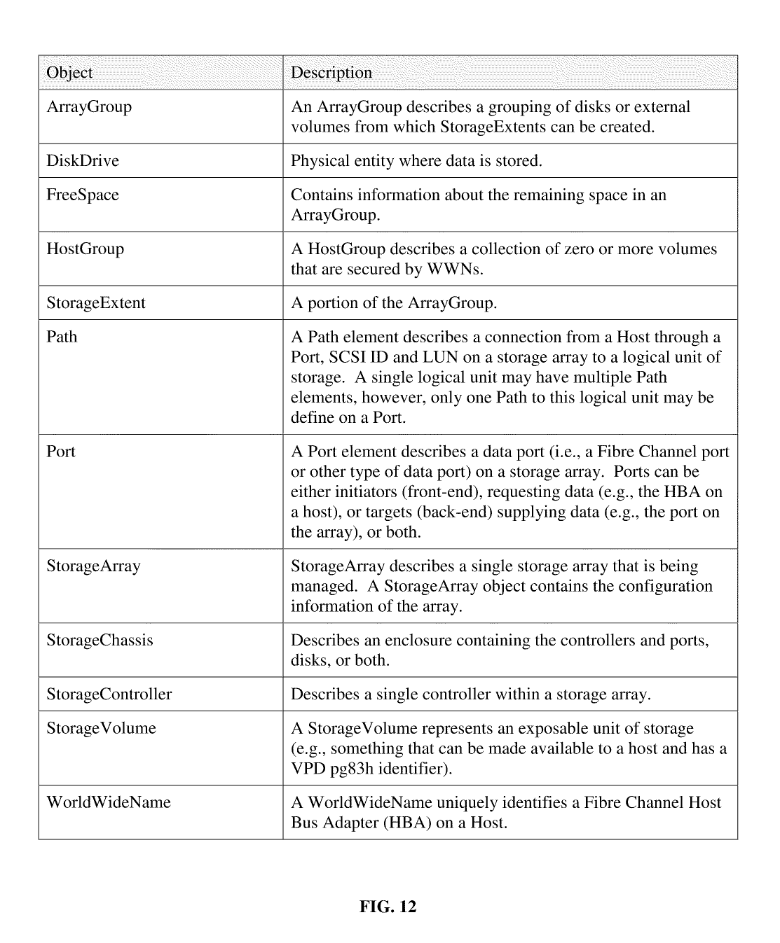

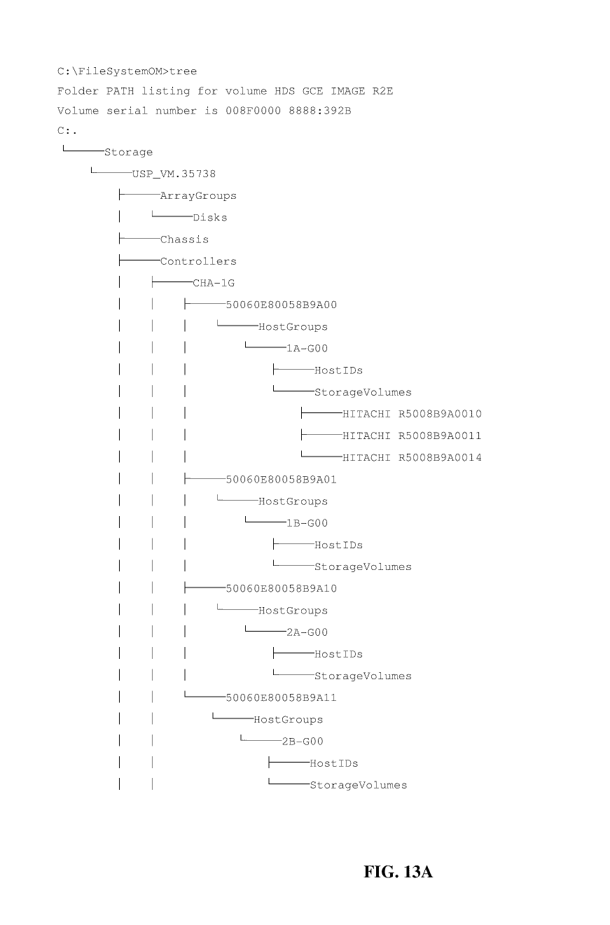

FIG. 12 shows the object descriptions for the diagram of FIG. 11. An ArrayGroup describes a grouping of disks or external volumes from which logical devices or LDEVs can be created. A DiskDrive is a physical entity on which data is stored. The Free Space contains information about the remaining space in an Array Group. A HostStorageDomain describes a collection of zero or more volumes that are secured by World Wide Names or WWNs. A StorageExtent is a portion of the ArrayGroup. A Path element describes a connection from a Host through a Port, SCSI ID, and LUN on a storage array to a logical unit of storage. A single logical unit may have multiple Path elements; however, only one Path to this logical unit may be defined on a Port. A Port element describes a data port (i.e., a Fibre Channel port or some other type of data port) on a storage array. Ports can be either initiators (front-end) requesting data (e.g., the HBA on a host), or targets (back-end) supplying data (e.g., the port on the array), or both. A StorageArray describes a single storage array that is being managed. A StorageArray object contains the configuration information of the array. A StorageChassis describes an enclosure containing the controllers and ports, or disks, or both. A StorageController describes a single controller within a storage array. A StorageVolume represents an exposable unit of storage (e.g., storage that can be made available to a host and has a SCSI VPD page 83 identifier). A WorldWideName uniquely identifies a Fibre Channel Host Bus Adapter (HBA) on a Host.

D. File System Concepts

In order to create a meaningful file and directory structure, rules will need to be made to govern the placement of the files and directories. There can be many possible layouts; the example below is just one of them. The construction of the file and directory structure is based on the following rules:
1. There will be a “root” or base directory under which will be all the directories and files.
2. Objects will have identifiers that are unique in the context of their containing directory.
3. The directory tree will consist of two kinds of directories: (a) object directories, where the name of the directory is the unique identifier for that object, as per item 2 above, and (b) container directories, where the name of the directory is the name of the objects the container directory contains.
4. Object directories may have Container subdirectories. They shall not have Object subdirectories.
5. Container directories may have Object subdirectories. They shall not have Container subdirectories.
6. Object directories shall have one or more files containing the information about that object (e.g., the same data could be in different files with different file formats to make it easier for certain consumers to digest).
7. Container directories shall not have any files.

The steps utilized to create the file system following these rules are straightforward:
1. Create the root directory name (e.g., “Storage”).
2. Collect the data from the storage array.
3. Identify the directory names and locations for data objects (e.g., /Storage/<Array ID>/Ports, where <Array ID> will be a unique identifier for the array) and create the directories.
4. Identify the file names for data objects (e.g. Port_{—}1_A) and their location (e.g. /Storage/<Array ID>/Ports/Port_{—}1_A).
5. Identify the object properties to be returned for each object.
6. Identify the format for the contents of the files (e.g., XML, JSON, etc.) and create the files for the data objects.
7. Identify the directory names and locations for association objects (e.g., /Storage/<Array ID>/Volumes_To_DiskDrives) and create the directories.
8. Identify the file names for the association objects (e.g., Volume_{—}001_DiskDrives) and their location (e.g., /Storage/Volumes_To_DiskDrives/Volume_{—}001_DiskDrives)
9. Identify the format for the contents of the files (e.g., XML, JSON, etc.) (most likely the same format as for other files) and create the files for the association objects.

E. Example of How to Present as File System

E.1. Sample Data

The sample data consists of a storage array with the following objects:
(i) A unique identifier for the array of USP_VM.35738;
(ii) Controller CHA-1G, with Ports 50060E80058B9A00, 50060E80058B9A01, 50060E80058B9A10, and 50060E80058B9A11;
(iii) Controller CHA-2L, with ports 50060E80058B9A20, 50060E80058B9A21, 50060E80058B9A30, 50060E80058B9A31;
(iv) HostGroups 1A-00, 1B-000, 2A-000, 2B-000, 3A-000, 3B-000, 4A-000, 4B-000; and
(v) StorageVolumes HITACHI R5008B9A0010, HITACHI R5008B9A0011, HITACHI R5008B9A0014.

E.2. Tree View

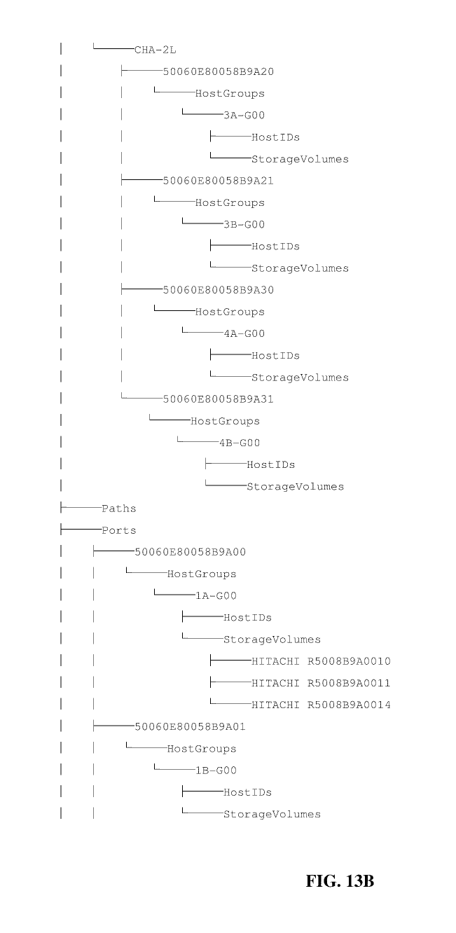

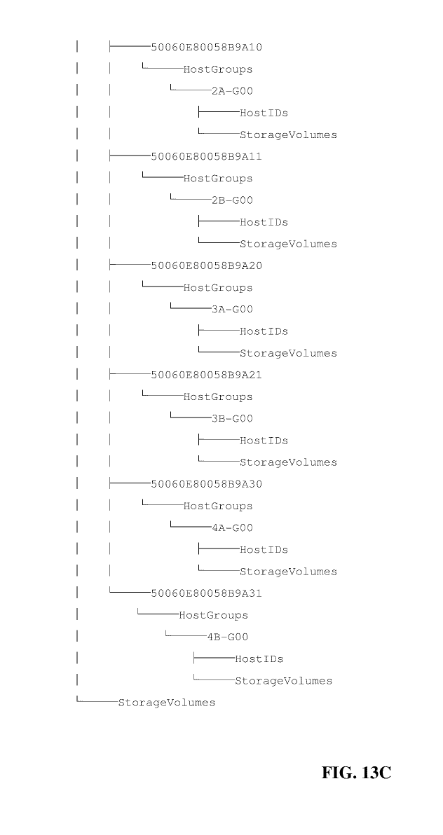

FIG. 13 shows a tree view of a sample directory listing (not all subdirectories implemented in this example are shown) using the Windows tree CLI command. The resource management scheme takes a complex object model and presents it through a file system of files and directories organized in a directory tree. The directory hierarchical structure lays out the object model and relationships between the objects. This allows gathering of system configuration information from simple file and directory commands, and allows manipulation of the configuration of the storage array through manipulation of the files and directories using standard file system CLIs (e.g., type, cat, del, etc.) and file system APIs (e.g., fwrite, fread, or other methods in the C programming language).

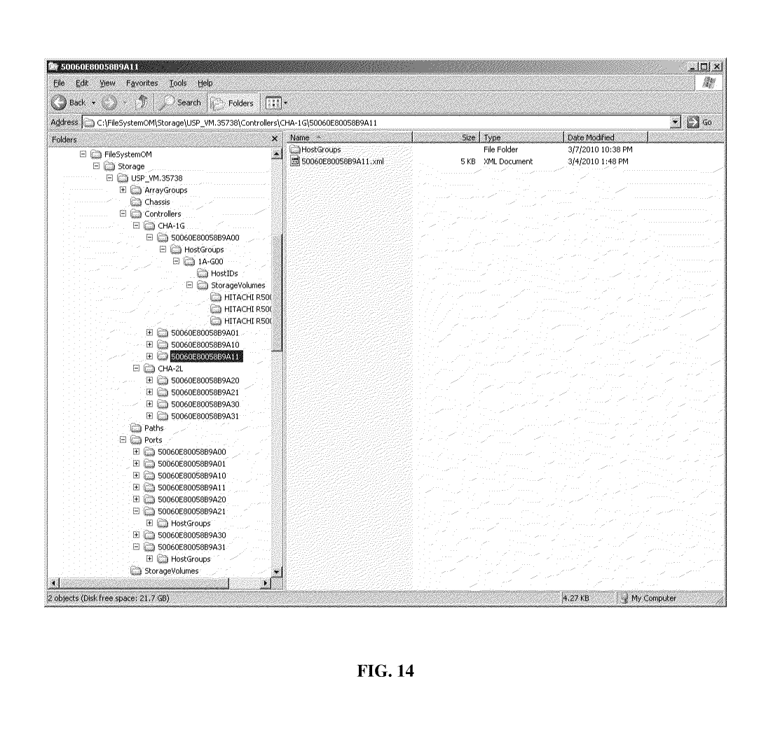

FIG. 14 shows the same sample directory listing using Windows Explorer in a tree/Explorer view (not all subdirectories implemented in this example are shown).

E.3. CLI Navigation

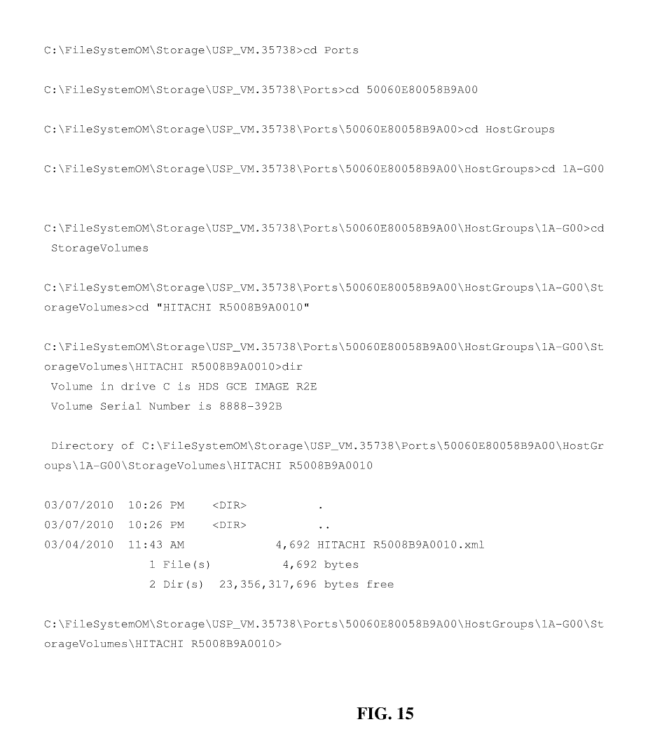

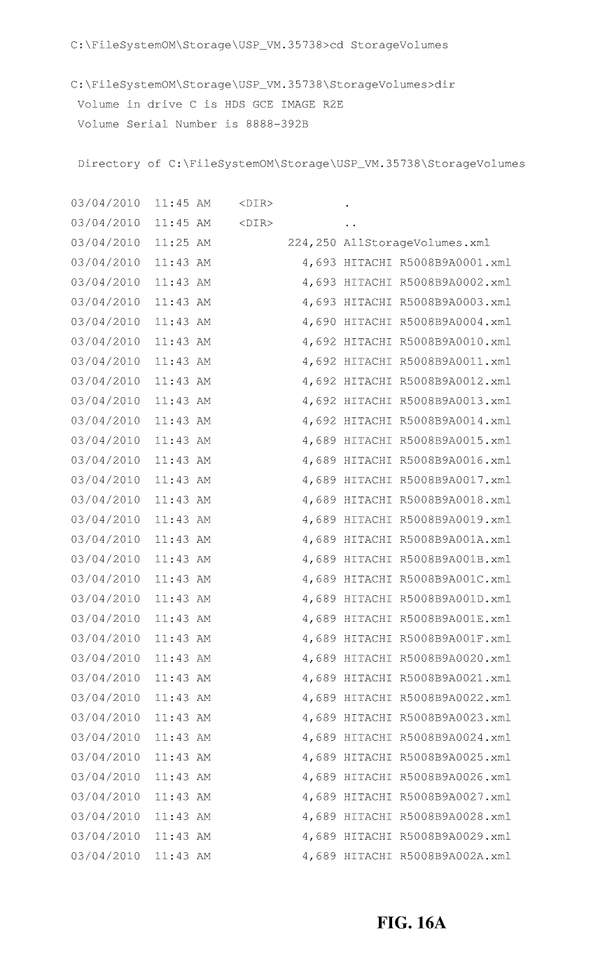

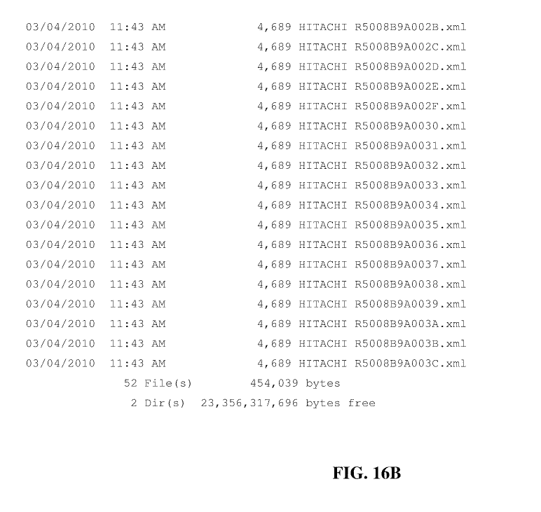

The user can easily maneuver through the directory tree as seen in the examples of FIG. 15 and FIG. 16. FIG. 15 shows a sample file directory view for C:\FileSystemOM\Storage\USP_VM.35738>cd Ports. FIG. 16 shows a sample file directory view for C:\FileSystemOM\Storage\USP_VM.35738>cd StorageVolumes.

E.4. Browser View

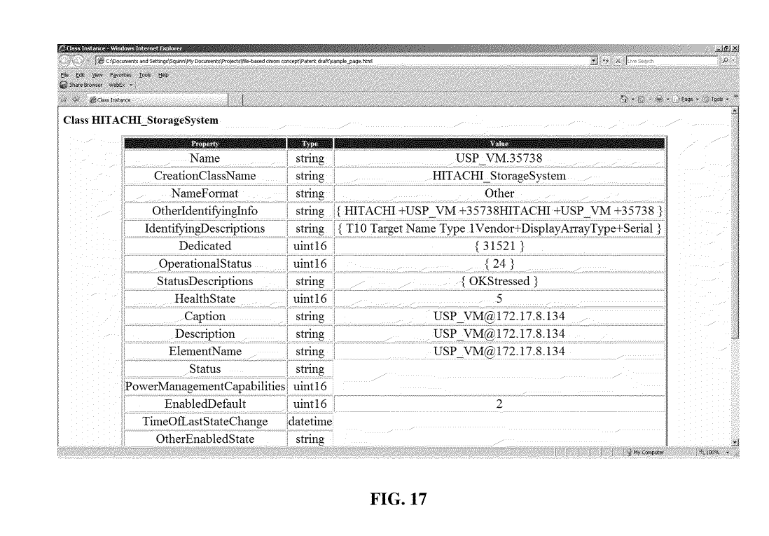

FIG. 17 shows an example of a Browser view of a file. In this example, Internet Explorer is used to view the file. The contents of the file are formatted at CIM-XML and an XSLT stylesheet is used to properly format the data. No web server is used, but only the native file browsing capabilities of the browser.

F. Filesystem in Userspace (FUSE)

The above detailed description has focused on using an actual file system and creating real on-disk files and directories. Another approach that could be used is to create a virtual file system that provides a file system API but does not actually have any physical files or directories. One such library that provides that file system API is the Filesystem in Userspace (FUSE) file system. The FUSE is a loadable kernel module for Unix-like computer operating systems, which allows non-privileged users to create their own file systems without editing the kernel code. This is achieved by running the file system code in user space, while the FUSE module only provides a “bridge” to the actual kernel interfaces.

By using a FUSE file system, code would be written that would be called when the file system APIs are called in the FUSE file system. This code would interact with the object model directly to provide the data needed for the file system APIs (e.g., return a directory listing, return file contents, read data from a file, write date to a file, etc.). For a FUSE file system, the above figures (e.g., FIGS. 2-4, 6, 8, and 10) do not change, but the File System Interface will be for a FUSE file system instead of the OS-supplied file system.

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for presenting an object model of a resource as a set of files and directories organized in a file directory tree which is used to manipulate the resource. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method for representing a computer-related resource in a computer-related system environment, the method comprising:
creating an object model of the resource, the object model including objects that correspond to components of the resource, configuration information of the objects, and relationships among the objects;
providing a resource application program interface to allow communication with and access to the components of the resource;
mapping the objects of the object model to files and directories of a file and directory structure;
presenting the file and directory structure via a file system application program interface to allow an application to manipulate the files and directories so as to manipulate the components of the resource via the resource application program interface; and
manipulating the components of the resource based on manipulation of the files and directories from the application.

2. The method according to claim 1,
wherein the file and directory structure is presented via a file system application program interface to allow an application to manipulate the files and the directories using file system command line interfaces and file system application program interfaces.

3. The method according to claim 1,
wherein the file and directory structure is presented on a graphical user interface display as a file directory tree laying out the object model and relationships among the objects as represented by the files and the directories in the file and directory structure.

4. The method according to claim 1,
wherein the object model further includes one or more association objects which do not correspond to components of the resource; and
wherein the one or more association objects are mapped to the file and directory structure.

5. The method according to claim 1, further comprising creating the file and directory structure which includes:
creating a root directory name for the resource;
collecting resource data from the resource;
identifying, for data objects, directory names and locations and file names and locations;
creating directories corresponding to the directory names and locations; and
identifying format for contents of files and creating the files corresponding to the file names and locations.

6. The method according to claim 5,
wherein the object model further includes one or more association objects which do not correspond to components of the resource;
wherein the one or more association objects are mapped to the file and directory structure; and
wherein creating the file and directory structure further includes:
identifying, for the one or more association objects, one or more directory names and locations and file names and locations;
creating directories corresponding to the directory names and locations for the one or more association objects; and
identifying format for contents of files and creating the files corresponding to the file names and locations for the one or more association objects.

7. The method according to claim 1, further comprising:
updating the object model based on changes in the file and directory structure; and
communicating with the resource to issue one or more configuration change requests based on the updated object model.

8. The method according to claim 1,
wherein the application is one of an operating system shell, a resource management application, or a Web server.

9. The method according to claim 1,
wherein each directory has a directory path which is used as a unique identifier to access instances based on scoping rules.

10. The method according to claim 1,
wherein the resource comprises a storage array having physical and logical components.

11. A system for representing a computer-related resource in a computer-related system environment, the system comprising:
a processor;
a memory;
an object model interface module to create an object model of the resource, the object model including objects that correspond to components of the resource, configuration information of the objects, and relationships among the objects;
a resource application program interface module to provide a resource application program interface to allow communication with and access to the components of the resource by converting object model requests to resource commands and vice versa;
an object model interface module to map the objects of the object model to files and directories of a file and directory structure; and
a file system interface module to present the file and directory structure via a file system application program interface to allow an application to manipulate the files and directories so as to manipulate the components of the resource via the resource application program interface.

12. The system according to claim 11,
wherein the file system interface is a file system application program interface to allow an application to manipulate the files and the directories via a command shell using file system command line interfaces and file system application program interfaces.

13. The system according to claim 11,
wherein the file system interface presents the file and directory structure on a graphical user interface display as a file directory tree laying out the object model and relationships among the objects as represented by the files and the directories in the file and directory structure.

14. The system according to claim 11,
wherein the object model further includes one or more association objects which do not correspond to the components of the resource; and
wherein the object model interface module maps the one or more association objects to the file and directory structure.

15. The system according to claim 11, wherein the object model interface module is configured to create the file and directory structure which includes:
creating a root directory name for the resource;
collecting resource data from the resource;
identifying, for data objects, directory names and locations and file names and locations;
creating directories corresponding to the directory names and locations; and
identifying format for contents of files and creating the files corresponding to the file names and locations.

16. The system according to claim 15,
wherein the object model further includes one or more association objects which do not correspond to the components of the resource;
wherein the object model interface module maps the one or more association objects to the file and directory structure; and
wherein creating the file and directory structure by the object model interface module further includes:
identifying, for the one or more association objects, one or more directory names and locations and file names and locations;
creating directories corresponding to the directory names and locations for the one or more association objects; and
identifying format for contents of files and creating the files corresponding to the file names and locations for the one or more association objects.

17. The system according to claim 11, wherein the object model interface module is configured to:
update the object model based on changes in the file and directory structure; and
communicate with the resource to issue one or more configuration change requests based on the updated object model.

18. A computer-readable storage medium storing a plurality of instructions for controlling a data processor to represent a computer-related resource in a computer-related system environment, the plurality of instructions comprising:
instructions that cause the data processor to create an object model of the resource, the object model including objects that correspond to components of the resource, configuration information of the objects, and relationships among the objects;
instructions that cause the data processor to provide a resource application program interface to allow communication with and access to the components of the resource;
instructions that cause the data processor to map the objects of the object model to files and directories of a file and directory structure; and
instructions that cause the data processor to present the file and directory structure via a file system application program interface to allow an application to manipulate the files and directories so as to manipulate the components of the resource via the resource application program interface.

19. The computer-readable storage medium according to claim 18,
wherein the file and directory structure is presented via a file system application program interface to allow an application to manipulate the files and the directories using file system command line interfaces and file system application program interfaces.

20. The computer-readable storage medium according to claim 18,
wherein the file and directory structure is presented on a graphical user interface display as a file directory tree laying out the object model and relationships among the objects as represented by the files and the directories in the file and directory structure.
